(19) United States
(12) Patent Application Publication
(10) Pub. No.: US 2011/0209000 A1
(43) Pub. Date: Aug. 25, 2011

(54) Systems and Methods for Allocating Network Resources From One Address Realm to Clients in a Different Address Realm

(75) Inventors: Tarik Hamman, Kista (SE); Anders Franzen, Transgund (SE); Mattias Holmqvist, Nacka (SE)

(73) Assignee: TELEFONAKTIEBOLAGET L M ERICSSON (PUBL), Stockholm (SE)

(21) Appl. No.: 13/122,768

(22) PCT Filed: Feb. 5, 2009
(86) PCT No.: PCT/IB09/00212

§ 371 Date: Apr. 6, 2011

Related U.S. Application Data
(60) Provisional application No. 61/103,439, filed on Oct. 7, 2008.

(51) Int. Cl. G06F 11/07; G06F 9/50

(52) U.S. Cl. 714/24; 714/2; 714/E11.023

(57) ABSTRACT

Disclosed is a method performed by a gateway server. The method may include the following steps: receiving from a client belonging to a first address realm a request for a network resource from a second address realm; allocating a network resource from the second address realm to the client in response to the request; detecting that the client is not able to communicate with the gateway server; in response to detecting that the client is not able to communicate with the gateway server, setting a retention timer, wherein the retention time is associated with the client; detecting the expiration of the retention timer if the retention timer has not been deactivated; and after detecting the expiration of the retention timer, adding the network resource to a set of available network resources.

### TECHNICAL FIELD

The present invention relates to the field of communications. More specifically, the aspects of the invention relate to gateways that allocate network resources to clients.

### BACKGROUND

Network Address Translation (NAT) has become a popular mechanism of enabling the separation of addressing realms. A NAT router must examine and change the network layer, and possibly the transport layer, header of each packet crossing the addressing realms that the NAT router is connecting. This causes the mechanism of NAT to violate the end-to-end nature of Internet connectivity, and disrupts protocols requiring or enforcing end-to-end integrity of packets.

An alternative to NAT is Realm Specific IP (RSIP) (see Request For Comment (RFC) 3102). RSIP is based on the concept of granting a client from one address realm a presence in another address realm by allowing the client to use network resources (e.g., network addresses, port numbers and/or other routing parameters) from the second address realm. An RSIP server replaces the NAT router, and RSIP-aware client on the private network are referred to as RSIP clients. RSIP requires ability of the RSIP server to grant such resources to RSIP clients.

RSIP allows a degree of address realm transparency to be achieved between two differently-scoped, or completely different address realms. This makes it a useful architecture for enabling end-to-end packet transparency between address realms. RSIP is expected to be deployed on privately addressed IPv4 networks and used to grant access to publicly addressed IPv4 networks. However, in place of the private IPv4 network, there may be an IPv6 network, or a non-IP network. Thus, RSIP allows IP connectivity to client on a host with an IP stack and IP applications but no native IP access. As such, RSIP can be used, in conjunction with DNS and tunneling, to bridge IPv4 and IPv6 networks, such that dual-stack hosts can communicate with local or remote IPv4 or IPv6 hosts.

Referring now to FIG. 1, in a typical scenario in which RSIP may be deployed, there is at least one client host 102 connected to a network 110a having one address realm (realm A), another client host 120 connected to a network 110b having a different address realm (realm B), and a gateway 104 that is connected to both networks 110a and 110b. As illustrated, hosts 102 and 120 belong to different address realms A and B, respectively. Gateway 104 has two interfaces: (1) Na on address realm A, and (2) Nb on address realm B. Executing on gateway 104 is an RSIP server 105 that has a pool of addresses in address realm B that it can allocate to or lend to a client 103 on client host 102 and other clients on other hosts in address realm A. These addresses can be denoted as Nb1, Nb2, Nb3 and so on.

As is often the case, hosts within address realm

A are likely to use private addresses while gateway 104 is multi-homed with one or more private addresses from address realm A in addition to its public addresses from address realm B. Thus, we typically refer to the realm in which client host 102 resides as “private” and the realm from which client host 102 borrows addressing parameters as the “public” realm. However, these realms may both be public or private. Moreover, address realm A may be an IPv6 realm or a non-IP address realm.

Client 103, wishing to establish an end-to-end connection to a client on client host 120 situated within address realm B, first negotiates and obtains assignment of public resources (e.g., addresses and other routing parameters of address realm B) from server 105. Upon allocation of these public resources, server 105 creates a mapping, referred to as a “bind”, of client 103's private addressing information and the allocated resources. Such a bind enables gateway 104 to correctly forward inbound traffic generated by client host 120 for client 103. According to the RSIP recommendation, a lease time should be associated with each bind.

Using the public resources allocated by server 105, client 103 tunnels data packets across network 110a to server 105. Server 105 acts as the end point of such tunnels, stripping off the outer headers and routing the inner packets onto the public realm (i.e., network 110b in the example shown in FIG. 1). As mentioned above, server 105 maps the public parameters allocated to client 103 to the private address used by client 103. When a packet from the public realm arrives at gateway 104 and it matches a bind, then server 105 will tunnel it to the appropriate host.

The RSIP RFC defines two basic flavors of RSIP: (1) RSA-IP and (2) RSAP-IP. When using RSA-IP, an RSIP server maintains a pool of available network addresses (e.g., IP addresses) to be leased by RSIP clients. Upon request, the RSIP server allocates an address to the client. Once an address is allocated to a particular client, only that client may use the address until the address is returned to the pool. Clients should not use addresses that have not been specifically allocated to them. The client may use any layer four address (e.g., TCP/UDP port) in combination with their allocated layer three (i.e., network) address.

When using RSAP-IP, an RSIP gateway maintains a pool of layer three and layer four addresses (e.g., IP addresses as well as pools of port numbers per address). RSIP hosts lease an IP address and one or more ports to use with it. Once an address/port tuple has been allocated to a particular client, only that client should use the tuple until it is returned to a pool. Clients should not use address/port combinations that have not been specifically allocated to them.

As mentioned above, RSIP recommends that each bind should be associated with a lease time. A short lease time is usually a prerequisite for efficient IP address and port resource utilization. However, such short lease times make the RSIP scheme vulnerable to disruptions in the communication link between the private hosts and the gateways.

It is possible that a failure in 110a may occur such that client 103 is not able to communicate with server 105 for some period of time. What is desired, therefore, are systems and methods handling such situations.

### SUMMARY

In on aspect, the present invention provides a method performed by a gateway server belonging to a first address realm and a second address realm. In some embodiments, the method includes the following steps: (1) receiving from a client belonging to the first address realm a request for a network resource from the second address realm; (2) allocating a network resource from the second address realm to the client in response to the request; (3) detecting that the client is not able to communicate with the gateway server; (4) in response to detecting that the client is not able to communicate with the gateway server, setting a retention timer, wherein the retention time is associated with the client; (5) detecting the expiration of the retention timer if the retention timer has not been deactivated; and (7) after detecting the expiration of the retention timer, adding the network resource to a set of available network resources.

In some embodiments, the method also includes deactivating the retention timer if the retention timer has not expired in response to receiving a communication from the client.

In some embodiments, the method also includes: receiving from a second client belonging to the first address realm a second request for a network resource from the second address realm; allocating a second network resource from the second address realm to the second client in response to the second request; detecting that the second client is not able to communicate with the gateway server; in response to detecting that the second client is not able to communicate with the gateway server, setting a second retention timer, wherein the second retention time is associated with the second client; detecting the expiration of the second retention timer if the second retention timer has not been deactivated; and after detecting the expiration of the second retention timer, adding the second network resource to the set of available network resources.

In some embodiments, the step of adding the first network resource to the set of available network resources is preformed in response to detecting that the first retention timer has expired.

In some embodiments, the method also includes setting a lease timer associated with the first network resource and determining whether the lease timer has expired after detecting the expiration of the first retention timer.

In some embodiments, the method also includes setting a lease timer associated with the first network resource, detecting the expiration of the lease timer, and determining whether the first retention timer has expired after detecting the expiration of the lease timer.

In some embodiments, the step of adding the first network resource to the set of available network resources is preformed in response to detecting that both the lease timer and the first retention timer have expired.

In some embodiments, the method also includes: receiving a message from the first client after setting the first retention timer, determining whether the first network resource has been allocated to another client after receiving the message, causing the first client to relinquish the first network resource in response to determining that the first network resource has been allocated to another client. The step of causing the first client to relinquish the first network resource may includes causing the first client to initiate an automatic restart or reboot.

In some embodiments, the method also includes: receiving a message from the first client after setting the first retention timer, determining whether the first network resource has been allocated to another client after receiving the message, and causing the other client to relinquish the network resource in response to determining (i) that the first network resource has been allocated to the other client and (ii) that the other client is executing on the host on which the gateway server is executing.

In some embodiments, the method also includes: receiving a message from the first client after setting the first retention timer, determining whether the first network resource has been allocated to another client after receiving the message, and causing the first client to relinquish the network resource in response to determining (i) that the first network resource has been allocated to the other client and (ii) that the other client is not executing on the host on which the gateway server is executing.

In some embodiments, the method also includes: receiving a message from the first client after setting the first retention timer, and, in response to receiving the message, determining whether it is possible that the first network resource has been allocated to another client. In some embodiments, the step of determining whether it is possible that the first network resource has been allocated to another client comprises determining whether the retention timer has expired. In some other embodiments, the step of determining whether it is possible that the first network resource has been allocated to another client comprises determining whether the retention timer has expired and determining whether a lease timer associated with the first network resource has expired.

In another aspect, the present invention provides a gateway server apparatus capable of belonging to a first address realm and a second address realm. In some embodiments, the gateway server apparatus includes: a data storage system that stores computer software; and a data processing system for executing the computer software, wherein the computer software comprises: (a) computer instructions for receiving a request transmitted from a client belonging to the first address realm for a network resource from the second address'realm; (b) computer instructions for allocating a network resource from the second address realm to the client in response to the request; (c) computer instructions for detecting that the client is not able to communicate with the gateway server apparatus; (d) computer instructions for setting a retention timer in response to detecting that the client is not able to communicate with the gateway server; (e) computer instructions for detecting the expiration of the retention timer if the retention timer has not been deactivated; and (f) computer instructions for adding the network resource to a set of available network resources after detecting the expiration of the retention timer.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 illustrates a communication system.

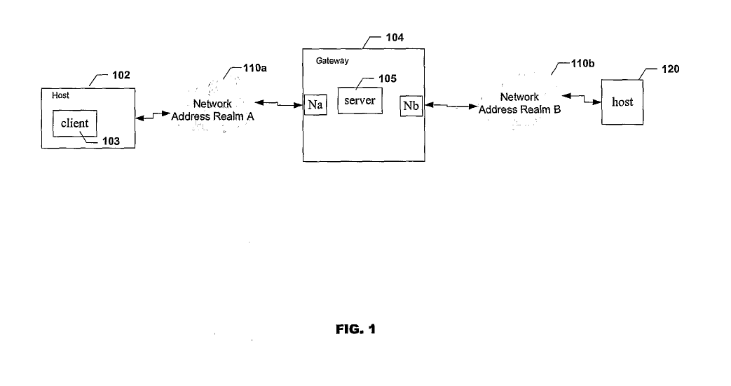

FIG. 2 illustrates a communication system according to an embodiment of the invention.

FIG. 3 is a flow chart illustrating a process according to an embodiment of the invention.

FIG. 4 is a flow chart illustrating a process according to an embodiment of the invention.

FIG. 5 is a flow chart illustrating a process according to an embodiment of the invention.

FIG. 6. is a functional block diagram of a gateway according to some embodiments of the invention.

### DETAILED DESCRIPTION

As used herein, the term “gateway” should be construed broadly to encompass not only gateways but also other like devices, such a routers.

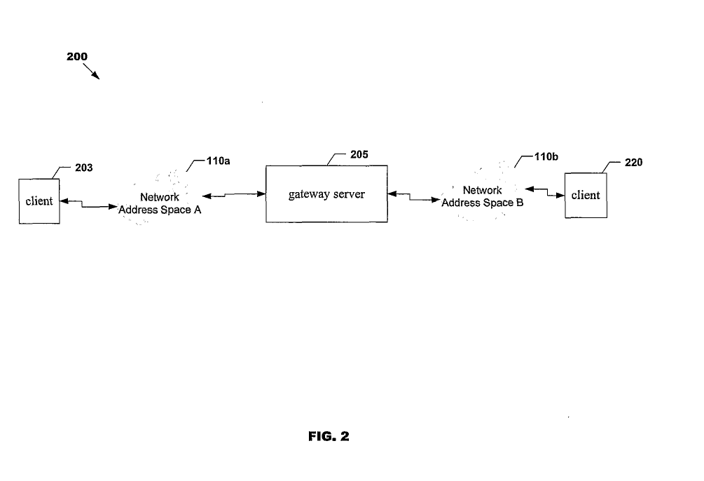

Referring now to FIG. 2, FIG. 2 is a functional block diagram illustrating a system 200 according to an embodiment of the invention. As shown in FIG. 2, system 200 includes a gateway server 205. As illustrated in FIG. 2, gateway server 205 belongs to both address realm A and address realm B. The gateway server 205 is configured to allocate network resources from address realm B to client 203 (e.g., an RSIP client), which belongs to address realm A. Client 203 may use the allocated network resource to communicate with a remote client 220. Gateway server 205 may be an RSIP server or may be similar to an RSIP server. A network resource may consist of a single network address (e.g., an Internet Protocol (IP) address) or a plurality of network address. In some embodiments, a network resource consists of a set of one or more network addresses and a set of one or more port numbers.

As discussed above, because short lease times are typically used in the RSIP scheme, the RSIP scheme is vulnerable to disruptions in the communication link between client 203 and the gateway server 205. Accordingly, in some embodiments, gateway server 205 is configured such that, for at least one bind (a.k.a., resource allocation), no lease time is associated with the bind. That is, the bind is “perpetual” or “permanent” until the client for which the bind was created relinquishes the allocated resources. However, a problem with creating a perpetual bind for client 203 may occur when there is a lengthy disruption to the communication channel between the client and the gateway server. In this scenario, it would be advantageous to return the resources allocated to the client to a pool of available resources.

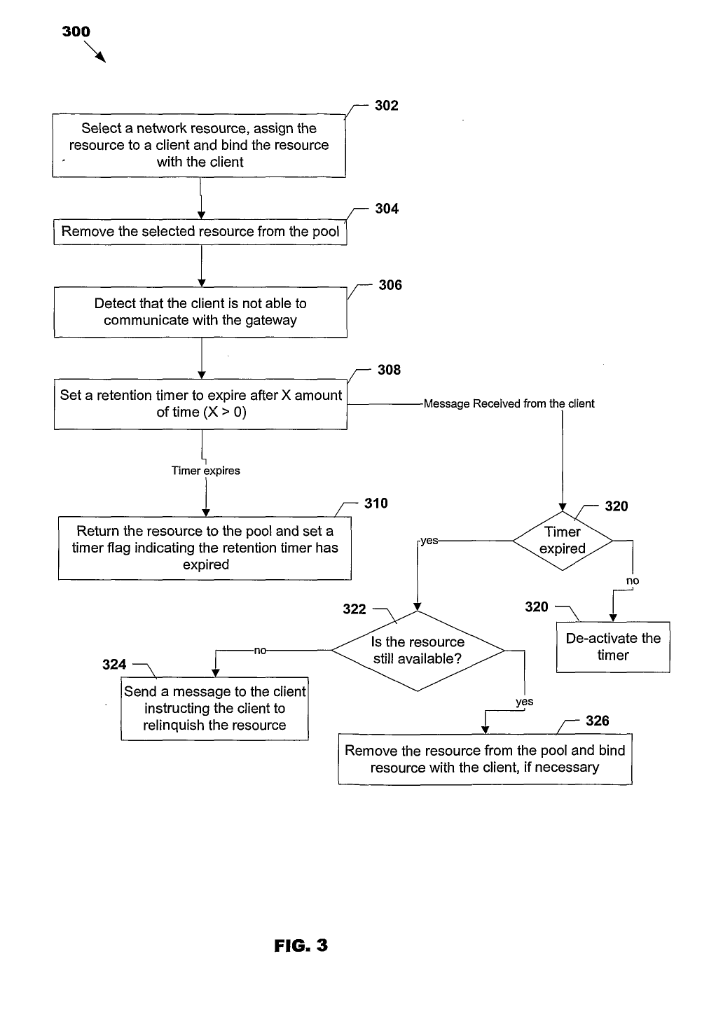

Accordingly, in some embodiments, gateway server 205 is configured to perform process 300 (see FIG. 3). Referring now to FIG. 3, process 300 may begin in step 302 where gateway server 205 selects a network resource (e.g., an IP address or a tuple consisting of an IP address and port number) from address realm B from a pool of available network resources from address realm B, assigns the selected network resource to client 203, which is in address realm A, and creates a bind for the assignment (i.e., maps the allocated resource to an identifier associated with client 203). Step 302 may be preformed in response to gateway server 205 receiving from client 203 a request for a network resource from address realm B.

In step 304, the allocated network resource is “removed” from the pool (e.g., a data structure may be updated to indicate that the allocated resource is no longer available).

In step 306, gateway server 205 detects that client 203 is not able to communicate with gateway server 205 (e.g., gateway server 205 detects a disruption in a communication channel or network that enabled client 203 to communicate with gateway server 205).

In response, gateway server 205 “sets” a retention timer (Tr) (step 308) to expire after some predetermined amount of time (e.g., 1 minute or less). In some embodiments, gateway server 205 sets the retention timer merely by recording the current time. Additionally, in step 308, gateway server 205 may undo the bind created in step 302 (e.g., gateway server 205 may remove from a data structure, such as a table, the information that mapped the allocated network resource to the identifier associated with the client).

When the timer expires, process 300 proceeds to step 310. The timer expires when the predetermined amount of time has elapsed. Accordingly, in the embodiment where gateway server 205 sets the timer merely by recording the current time, gateway server 205 may periodically determine the current time to check whether the predetermined amount of time has elapsed since the timer was set.

In step 310, gateway server 205 returns to the pool the network resource selected and allocated in step 302 and may set a timer flag indicating that the timer has expired.

If, after performing step 308, gateway server 205 receives from client 203 a message containing the network resource that was allocated to client 203 in step 302, then process 300 proceeds to step 320.

In step 320, gateway server 205 determines whether the retention timer has expired (e.g., gateway server 205 checks the status of the timer flag). If the timer has expired, process 300 proceeds to step 322, otherwise it proceeds to step 330, where gateway server 205 deactivates the retention timer.

In step 322, gateway determines whether the network resource is in the pool of available network resources (e.g., the network resource has not been allocated to another client). If the network resource is not in the pool, then gateway server 205 transmits a message to client 203 that causes client 203 to relinquish the network resource (e.g., the message may cause client 203 to perform an automatic re-start or re-boot) (step 324). If it is in the pool, then gateway server 205 removes the network resource from the pool (step 326). Additionally, in step 326, gateway server 205 may bind the network resource to client 203. After step 326, client 203 continues as before the occurrence of the disruption of the communication channel.

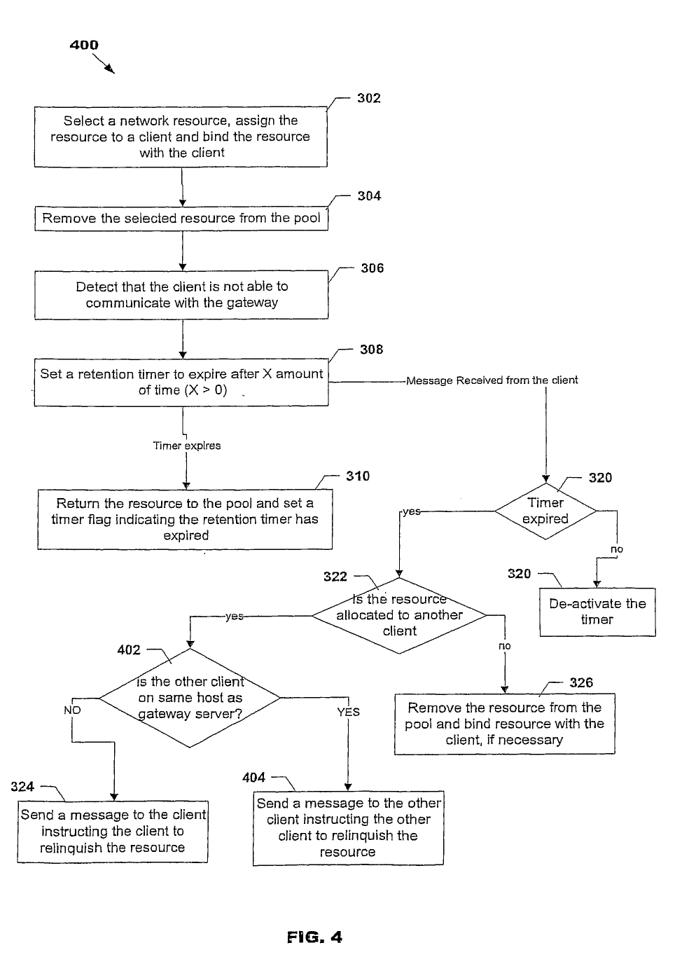

Referring now to FIG. 4, FIG. 4 is a flow chart illustrating a process 400, according to embodiments of the invention, that may be performed by gateway server 205. Process 400 is identical to process 300 with the exception that after determining, in step 322, that the network resource has been allocated to another client and is, thus, no longer available, step 402 is performed. In step 402, gateway server 205 determines whether the other client to which the network resource has been allocated is executing on the host on which gateway server 205 is executing. If the other client and gateway server 205 are not executing on the same host, then step 324 is performed, otherwise step 404 is performed. In step 404, gateway server 205 transmits a message to the other client that causes the other client to relinquish the network resource (e.g., the message may cause the other client to perform an automatic re-start or re-boot of the host).

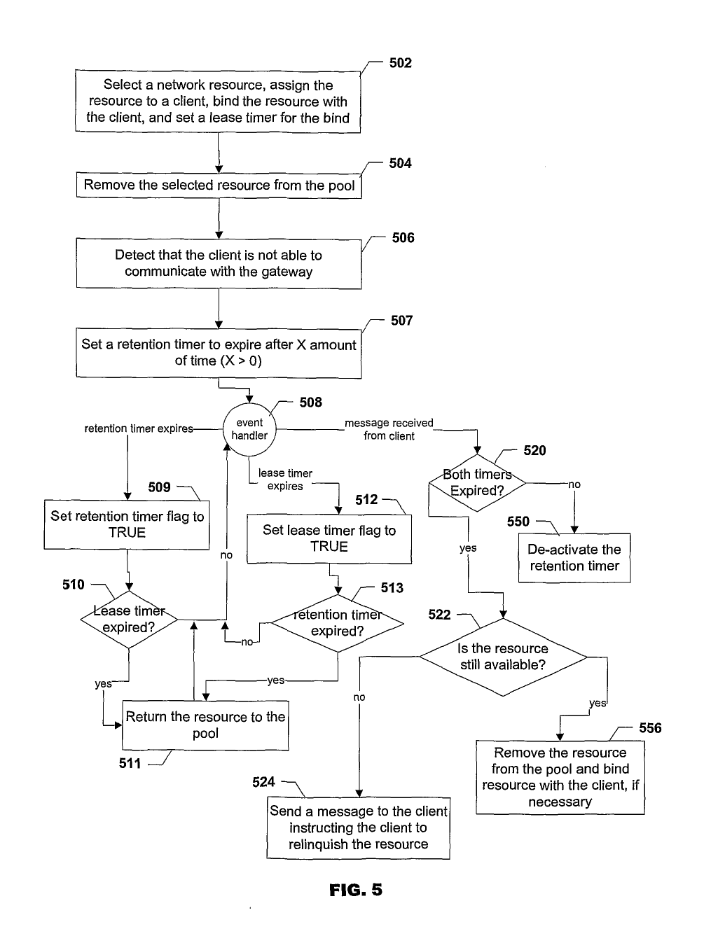

Referring now to FIG. 5, FIG. 5 is a flow chart illustrating a process 500, according to embodiments of the invention, that may be performed by gateway server 205.

Process 500 assumes that a network resource allocated to client 203 is associated with a lease timer.

Process 500 may begin in step 502 where gateway server 205 selects a network resource from address realm B from a pool of such available network resources, assigns the selected network resource to client 203, creates a bind for the assignment (i.e., maps the allocated resource to an identifier associated with client 203), and sets a lease timer associated with the bind to expire after some predetermined amount of time. Step 502 may be preformed in response to gateway server 205 receiving from client 203 a request for a network resource from address realm B. In step 504, the allocated resource is “removed” from the pool (e.g., a data structure may be updated to indicate that the allocated resource is no longer available).

In step 506, gateway server 205 detects that client 203 is not able to communicate with gateway server 205 (e.g., gateway server 205 detects a disruption in a communication channel or network that enabled client 203 to communicate with gateway server 205).

In response, gateway server 205 sets a retention timer (Tr) (step 507) to expire after a predetermined amount of time. Additionally, in step 507, gateway server 205 may undo the bind created in step 502 (e.g., gateway server 205 may remove from a data structure, such as a table, the information that mapped the allocated resource to the identifier associated with the client). After step 507, control may be passed to an event handler 508.

When the retention timer expires, process 500 proceeds to step 509. In step 509, gateway sets a retention timer flag indicating that the retention timer has expired. In step 510, gateway server 205 determines whether the lease timer has expired. If it has expired, process 500 proceeds to step 511. In step 511, gateway server 205 returns to the pool the network resource selected and allocated in step 502.

When the lease timer expires, process 500 proceeds to step 512. In step 512, gateway sets a lease timer flag indicating that the lease timer has expired. In step 513, gateway server 205 determines whether the retention timer has expired (e.g., gateway server 205 checks status of the retention timer flag). If it has expired, process 500 proceeds to step 511.

If after performing step 507 gateway server 205 receives from client 203 a message containing the network resource that was allocated to client 203 in step 502, then process 500 proceeds to step 520.

In step 520, gateway server 205 determines whether both the retention timer and lease timer have expired (e.g., gateway server 205 checks the status of the timer flags). If the timers have expired, process 500 proceeds to step 522, otherwise it proceeds to step 530, where gateway server 205 deactivates the retention timer.

In step 522, gateway server 205 determines whether the resource selected and allocated in step 502 is in the pool of available resources (e.g., the resource has not been allocated to another client). If the resource is not in the pool, then gateway server 205 transmits a message to client 203 that causes client 203 to relinquish the resource (e.g., the message may cause client 203 to perform an automatic re-start or re-boot) (step 524). If it is in the pool, then gateway server 205 removes the resource from the pool (step 556). Additionally, in step 556, gateway server 205 may bind the resource to client 203. After step 556, client 203 continues as before the occurrence of the disruption of the communication channel.

In some embodiments, after determining, in step 522, that the resource has been allocated to another client, gateway server 205 determines whether the other client to which the resource has been allocated is executing on the host on which gateway server 205 is executing. If the other client and gateway server 205 are not executing on the same host, then step 524 is performed, otherwise gateway server 205 transmits a message to the other client that causes the other client to relinquish the resource (e.g., the message may cause the other client to perform an automatic re-start or re-boot of the host).

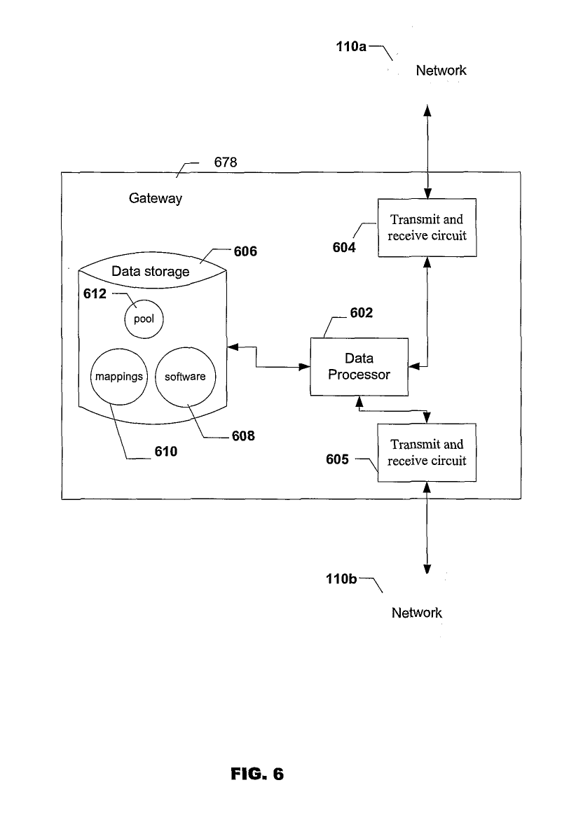

Referring now to FIG. 6, FIG. 6 is a functional block diagram of a gateway 678 according to some embodiments of the invention. In general, gateway 678 may comprise a processing system 602 (e.g., one or more microprocessors), a data storage system 606 (e.g., one or more non-volatile storage devices) and computer software 608 stored in storage system 606. Information 612 identifying a pool of available network resources (e.g., IP addresses and port numbers) and/or mapping information 610 that maps allocated resources to clients may also be stored by data storage system 606. Gateway 678 may comprise a first network interface 604 (e.g., transmit/receive (Tx/Rx) circuitry) for transmitting data to and receiving data from network 110a and a second network interface 605 (transmit/receive (Tx/Rx) circuitry) for transmitting data to and receiving data from network 110b.

Software 608 is configured such that when processing system 602 executes software 608, gateway 678 performs steps described above (e.g., steps described above with reference to the flow charts shown in FIGS. 3-5). That is software 608 implements the functionality of gateway server 205

For example software 608 may include: computer instructions for allocating a network resource to a client; computer instructions for detecting that the client is not able to communicate with the gateway; computer instructions for setting a retention timer in response to detecting that the client is not able to communicate with the gateway; computer instructions for receiving a message from the client; computer instructions for determining whether the retention timer has expired in response to receiving the message; and computer instructions for determining whether the network resource is available in response to determining that the retention timer has expired.

The above described embodiments improve resiliency handling. Thus, greater network robustness and in-service-performance can be achieved.

While various embodiments of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and steps may be performed in parallel.

1. A method performed by a gateway server belonging to a first address realm and a second address realm, comprising:
receiving from a client belonging to the first address realm a request for a network resource from the second address realm;
allocating a network resource from the second address realm to the client in response to the request;
prior to determining that the client should relinquish the network resource, (a) detecting that the client is not able to communicate with the gateway server and (b) setting a retention timer in response to detecting that the client is not able to communicate with the gateway server, wherein the retention time is associated with the client;
detecting the expiration of the retention timer if the retention timer has not been deactivated; and
after detecting the expiration of the retention timer, adding the network resource to a set of available network resources.

2. The method of claim 1, further comprising deactivating the retention timer if the retention timer has not expired, wherein the deactivating step is performed in response to receiving a communication from the client.

3. The method of claim 1, further comprising:
receiving from a second client belonging to the first address realm a second request for a network resource from the second address realm;
allocating a second network resource from the second address realm to the second client in response to the second request;
detecting that the second client is not able to communicate with the gateway server;
in response to detecting that the second client is not able to communicate with the gateway server, setting a second retention timer, wherein the second retention time is associated with the second client;
detecting the expiration of the second retention timer if the second retention timer has not been deactivated; and
after detecting the expiration of the second retention timer, adding the second network resource to the set of available network resources.

4. The method of claim 3, wherein the step of adding the first network resource to the set of available network resources is preformed in response to detecting that the first retention timer has expired.

5. The method of claim 3, further comprising setting a lease timer, wherein the lease timer is associated with the first network resource.

6. The method of claim 5, further comprising determining whether the lease timer has expired after detecting the expiration of the first retention timer.

7. The method of claim 5, further comprising:
detecting the expiration of the lease timer; and
after detecting the expiration of the lease timer, determining whether the first retention timer has expired.

8. The method of claim 5, wherein the step of adding the first network resource to the set of available network resources is preformed in response to detecting that both the lease timer and the first retention timer have expired.

9. The method of claim 3, further comprising:
after setting the first retention timer, receiving a message from the first client; and
after receiving the message, determining whether the first network resource has been allocated to another client.

10. The method of claim 9, further comprising causing the first client to relinquish the first network resource in response to determining that the first network resource has been allocated to another client.

11. The method of claim 10, wherein the step of causing the first client to relinquish the first network resource comprises causing the first client to initiate an automatic restart or reboot.

12. The method of claim 9, further comprising causing the other client to relinquish the network resource in response to determining (i) that the first network resource has been allocated to the other client and (ii) that the other client is executing on the host on which the gateway server is executing.

13. The method of claim 9, further comprising causing the first client to relinquish the network resource in response to determining (i) that the first network resource has been allocated to the other client and (ii) that the other client is not executing on the host on which the gateway server is executing.

14. The method of claim 1, further comprising:
after setting the retention timer, receiving a message from the client; and
determining whether it is possible that the network resource has been allocated to another client in response to receiving the message.

15. The method of claim 14, wherein the step of determining whether it is possible that the network resource has been allocated to another client comprises determining whether the retention timer has expired.

16. The method of claim 15, wherein the step of determining whether it is possible that the network resource has been allocated to another client further comprises determining whether a lease timer associated with the network resource has expired.

17. A gateway server apparatus capable of belonging to a first address realm and a second address realm, comprising:
a data storage system that stores computer software; and
a data processing system for executing the computer software, wherein the computer software comprises:
(a) computer instructions for receiving a request transmitted from a client belonging to the first address realm for a network resource from the second address realm;
(b) computer instructions for allocating a network resource from the second address realm to the client in response to the request;
(c) computer instructions for detecting that the client is not able to communicate with the gateway server apparatus prior to determining that the client should relinquish the network resource;
(d) computer instructions for setting a retention timer in response to detecting that the client is not able to communicate with the gateway server prior to determining that the client should relinquish the network resource;
(e) computer instructions for detecting the expiration of the retention timer if the retention timer has not been deactivated; and
(f) computer instructions for adding the network resource to a set of available network resources after detecting the expiration of the retention timer.

18. The gateway server apparatus of claim 17, wherein the computer software further comprises computer instructions for deactivating the retention timer in response to receiving a communication from the client.

19. The gateway server apparatus of claim 17, wherein the computer software further comprises:
computer instructions for receiving a second request transmitted from a second client belonging to the first address realm for a network resource from the second address realm;
computer instructions for allocating a second network resource from the second address realm to the second client in response to the second request;
computer instructions for detecting that the second client is not able to communicate with the gateway server apparatus;
computer instructions for setting a second retention timer in response to detecting that the second client is not able to communicate with the gateway server;
computer instructions for detecting the expiration of the second retention timer; and
computer instructions for adding the second network resource to the set of available network resources in response to detecting the expiration of the second retention timer.

20. The gateway server apparatus of claim 19, wherein the computer software is configured such that the computer instructions for adding the first network resource to the set of available network resources are executed in response to the expiration of the first retention timer.

21. The gateway server apparatus of claim 19, wherein the computer software further comprises computer instructions for setting a lease timer associated with the first network resource.

22. The gateway server apparatus of claim 21, wherein the computer software further comprises computer instructions for determining whether the lease timer has expired, wherein the computer software is configured such that said computer instructions for determining whether the lease timer has expired are executed in response to the first retention timer expiring.

23. The gateway server apparatus of claim 21, wherein the computer software further comprises:
computer instructions for detecting the expiration of the lease timer; and
computer instructions for determining whether the first retention timer has expired, wherein the computer software is configured such that said computer instructions for determining whether the first retention timer has expired are executed in response to the expiration of the lease timer being detected.

24. The gateway server apparatus of claim 21, wherein the computer software is configured such that the computer instructions for adding the first network resource to the set of available network resources are executed in response to a determination that both the lease timer and the first retention timer have expired.

25. The gateway server apparatus of claim 17, wherein the computer software further comprises computer instructions for determining whether the network resource has been allocated to another client in response to the reception at the gateway server apparatus of a message transmitted from the client after the retention timer was set.

26. The gateway server apparatus of claim 25, wherein the computer software further comprises computer instructions for causing the client to relinquish the network resource, wherein the computer software is configured such that said computer instructions for causing the client to relinquish the network resource are executed in response to a determination that the network resource has been allocated to another client.

27. The gateway server apparatus of claim 26, wherein the computer instructions for causing the client to relinquish the network resource comprises computer instructions for causing the client to initiate an automatic restart or reboot.

28. The gateway server apparatus of claim 25, wherein the computer software further comprises computer instructions for causing the other client to relinquish the network resource in response to a determination that (i) the network resource has been allocated to the other client and (ii) the other client is executing on the gateway server apparatus.

29. The gateway server apparatus of claim 25, wherein the computer software further comprises computer instructions for causing the client to relinquish the network resource in response to a determination that (i) the network resource has been allocated to the other client and (ii) the other client is not executing on the gateway server apparatus.

30. The gateway server apparatus of claim 17, wherein the computer software further comprises computer instructions for determining whether it is possible the network resource has been allocated to another client in response to the reception at the gateway server apparatus of a message transmitted from the client after the retention timer was set.

31. The gateway server apparatus of claim 30, wherein the computer instructions for determining whether it is possible that the first network resource has been allocated to another client comprises computer instructions for determining whether the retention timer has expired.

32. The gateway server apparatus of claim 31, wherein the computer instructions for determining whether it is possible that the network resource has been allocated to another client further comprises computer instructions for determining whether a lease timer associated with the network resource has expired.
